(19) United States
(12) Patent Application Publication
(10) Pub. No.: US 2021/0278129 A1
(43) Pub. Date: Sep. 9, 2021

(54) PERISHABLE ITEM STORAGE DEVICE

(71) Applicants: Thomas James Cote, Woodinville, WA (US); Kristopher Lane Daniels, Kirkland, WA (US); Marcus Alexandr Horstmann, Woodinville, WA (US)

(72) Inventors: Thomas James Cote, Woodinville, WA (US); Kristopher Lane Daniels, Kirkland, WA (US); Marcus Alexandr Horstmann, Woodinville, WA (US)

(21) Appl. No.: 17/327,696

(22) Filed: May 22, 2021

Related U.S. Application Data
(63) Continuation-in-part of application No. 16/376,218, filed on Apr. 5, 2019.
(60) Provisional application No. 62/654,522, filed on Apr. 8, 2018.

(51) Int. Cl. F25D 29/00; G06F 16/538; G06Q 10/08

(52) U.S. Cl. CPC F25D 29/008; G06F 16/538; F25D 2400/361; F25D 2700/06; G06Q 10/087

(57) ABSTRACT

A storage unit such as a refrigerator applies object identification technology automatically to identify items as they are placed in and removed from the storage unit. Embodiments further include weight sensors enabling the device to determine an item's weight. A means is provided for deriving an expiry date for an item identified as perishable. Inventory records are created and stored in a structured database, comprising the identities and quantities of items and providing a means for deriving an expiry date if the item is perishable. An interactive display enables actionable and supervisory information exchange between the user and the storage unit. A provider interface enables item ordering transactions with item providers.

### CROSS-REFERENCE TO RELATED APPLICATION

This application is a continuation-in-part of U.S. utility patent application Ser. No. 16/376,218, filed Apr. 5, 2019 and claims the benefit of U.S. provisional patent application Ser. No. 62/654,522, filed Apr. 8, 2018, both incorporated herein by reference.

### BACKGROUND OF THE INVENTION

### Field of the Invention

This invention relates to devices for storage of perishable items of limited usable lifespans, including, in particular, refrigerators used for the storage of perishable foodstuffs.

### Description of the Related Art

Various methods have been employed for managing inventories of stored items from the earliest days of civilization.

Earliest efforts to manage perishable inventories entailed tedious manual tabulation of items as they were entered into and removed from storage. Some more recent efforts to automate such management have been limited to items packaged with bar codes such as the Universal Product Code, enabling inventory management, identifying and tracking such items by scanning them as they move in and out of inventory. These approaches utilize bar code scanning technology, such as employed in automated Point-of-Sale systems, to scan bar code tags attached to food items in order to create and maintain an inventory of stored items. Exemplary of such technology is the semiconductor equipment and freezer described in U.S. Pat. No. 6,519,963 to Maeda. Analogous technologies utilize radio transmitting tags, such as radio frequency identification (RFID) tags, near field communication (NFC) tags or similar technologies to identify and track tagged inventory items, such as claimed in U.S. Pat. No. 6,892,545 to Ishikawa et al.

Approaches that require scanning tags attached to items for creating an inventory are subject to a number of limitations, however, and first among these is that such technologies require that every item to be inventoried must be labeled with a coded tag. Furthermore, each item must be scanned when it enters inventory and again when it is removed from inventory. Yet further, scanning of tags in itself cannot inventory contents of items, such as beverages in containers, that become depleted in use over time while in inventory.

Some recent efforts have applied artificial intelligence technology to the task of creating and managing an inventory of perishable items. Many of these efforts, such as that described by Shweta in Intelligent Refrigerator Using Artificial Intelligence (presented at the 2017 11^{th} International Conference on Intelligent Systems and Control) have been limited to particular kinds of items such as fresh vegetable produce and are not suitable for maintaining and managing a highly diversified inventory of perishable items such as those kept in the usual consumer's refrigerator.

Wang et al. in U.S. Pat. No. 9,784,497 describe a system that trains a computerized convolutional neural network to recognize images of food items in a refrigerator and thereby create an inventory of the identity and location of items in the refrigerator. This technology, however, like the tag scanning technology, by itself cannot inventory contents of packaged items that become depleted while in inventory.

Other modern approaches, exemplified by U.S. patent application publication number 2015/0178654 to Glasgow et al., leverage electronic sensors and machine vision to manage stocks of items as their inventory is depleted in use. Such methods, however, like all the other art discussed above, have not heretofore provided intelligent management of inventories of perishable items with varied useable lifetimes. It has been estimated that the average household in a developed nation wastes 40% of their yearly food purchases. Such waste is largely the result of inadequate management of inventories of perishable food items.

Determining the “best used by” date of an individual perishable item in inventory has proven a challenge in the prior art. In the RFID tag based technology described by Rozendaal et al. in U.S. Pat. No. 7,861,542, the tag for each item is programmed with the expiration date of the item. This approach suffers from the general limitation of all tagging technologies in that it requires each item to be tagged in order to be tracked.

Another approach, described in U.S. Pat. No. 9,965,798 to Vaananen, utilizes computer vision to identify and scan freshness dates on food containers. A significant limitation to this approach is that many perishable items, for example vegetable produce, are generally not labeled with freshness dates. Yet another approach, proposed by Minvielle in U.S. Pat. No. 9,528,972, uses “nutritional substance attribute sensors” to detect optical, spectroscopic or chemical indicators of spoilage of items in inventory. A limitation to this approach, besides reduction to practice, is that it doesn't provide “best used by” information. Rather, it simply identifies items in the process of spoiling.

What is needed is a way for a refrigerator, or other food storage unit such as a cabinet or pantry, to track perishable items automatically as they are placed in and removed from storage. What is needed further is a such device that tracks items in the form in which they are acquired by the user, without requiring additional tagging, labeling or other intervention by the user. Further, what is needed is a device that provides guidance for intelligent management of inventories of perishable items with varied usable lifetimes. Yet further, what is needed is a storage unit that tracks amounts of containerized items that are depleted over time in inventory. As a practical solution to reduce household food waste, it is desirable that embodiments of such a device be implemented as cost effective and simple retrofits to existing refrigerators.

### SUMMARY OF THE INVENTION

This storage unit, such as a refrigerator, cabinet or pantry, uses at least one sensor such as a camera or lidar scanner disposed within it, to acquire data on the storage unit's contents. The device applies object identification technology to processes the data thus acquired, automatically identifying items as they are placed in and removed from the storage unit. Embodiments further include weight sensors enabling the device to determine an item's weight. A means is provided for deriving an expiry date for an item identified as perishable. A database engine enters inventory records in a structured database, a record comprising the identity and quantity of an item along with information for deriving an expiry date if the item is perishable. An interactive display provides a user interface that enables actionable and supervisory information exchange between the user and the storage unit. A provider interface enables item ordering transactions with item providers.

### BRIEF DESCRIPTION OF THE DRAWINGS

Objects of the present invention as well as advantages, features and characteristics, in addition to methods of operation, function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 illustrates an exemplary configuration of a refrigerator according to an embodiment of the invention;

FIG. 2 is a simple flowchart illustrating acquisition and updating of inventory data in an embodiment of the invention;

FIG. 3a is a flowchart illustrating the creation of a simple display highlighting items in inventory soon to expire in an embodiment of the invention;

FIG. 3b is a flowchart showing how an embodiment of the invention provides an alert regarding soon to expire items and a suggested user action to the invention's interactive display in an embodiment of the invention;

FIG. 4 is a flowchart providing details of suggested user action regarding using a soon to expire recipe, in an embodiment of the invention;

FIG. 5 is a simplified flowchart illustrating how an embodiment invokes an item ordering interface that is used by the user on the interactive display to place delivery orders to providers for items for which a shortfall has been detected;

FIG. 6 is a flowchart illustrating a routine for embodiments of the device to create a meal plan optimizing the use of soon to expire items and providing means to obtain needed items; and

FIG. 7 is a block diagram illustrating one embodiment of the invention.

### DETAILED DESCRIPTION OF THE INVENTION

In a typical embodiment of the invention, one or more image sensors are disposed within the target storage unit. Image sensors may be cameras, lidar scanners, sonar, radar or other devices suitable for obtaining a representation of the contents of the storage unit in the form of image data. Sensors are so situated within the storage unit that the images obtained by the sensors encompasses objects stored within the storage unit. Image sensors may be statically mounted to receive a constant perspective of the interior of the storage unit. Alternatively, image sensors may employ reciprocating motors to pivot and scan wide areas of the storage unit. Embodiments may mount image sensors near the opening of the storage unit. Such placement advantageously results in image capture by a sensor at the demarcation point between item entry into and item removal from the storage unit, thereby facilitating inventory tracking.

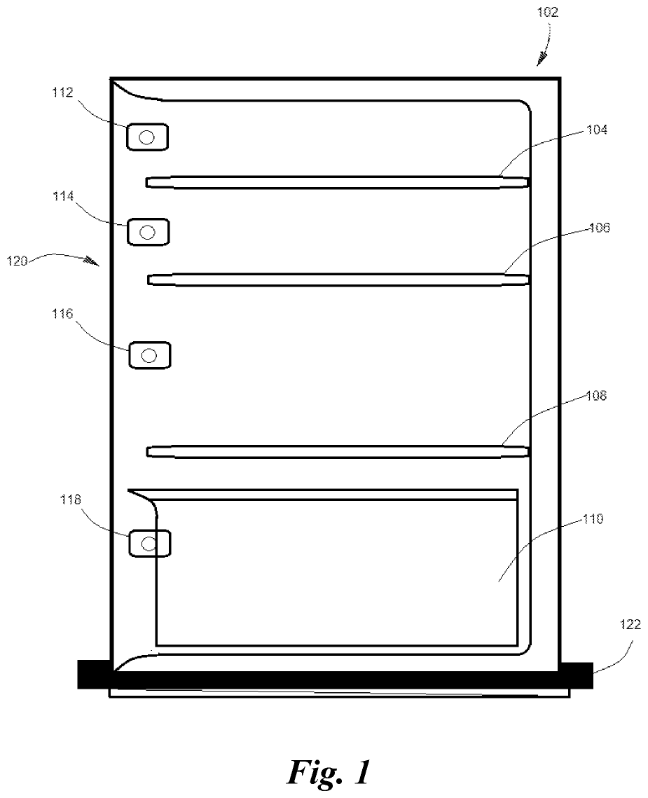

Turning to the drawings, FIG. 1 shows a cross-section of a storage unit in the form of an exemplary refrigerator. Disposed within refrigerator 102 are storage surfaces such as shelves 104, 106, 108 and drawer 110 for receiving and holding items in inventory. Image sensors 112, 114, 116, 118 are mounted in refrigerator 102 and positioned to record images of items on the corresponding storage surfaces (shelves 104, 106, 108, and drawer 110) as the items are placed into and removed from the storage unit. In the depicted embodiment, sensors 112, 114, 116, 118 are advantageously mounted near the opening 120 of refrigerator 102.

In the depicted embodiment, refrigerator 102 is disposed upon weight sensor 122, which provides signals corresponding to the gross weight of refrigerator 102 and its contents. Simple tare calculations based upon the weight measurements provided by weight sensor 122 facilitate tracking of inventory, including that of items, such as beverage containers, whose contents may be depleted with use over time.

The image sensors are in communication with image processing equipment which receives storage unit content image data from the sensors. It will be understood by those of skill in the art that the image processing equipment associated with this device may be local to the storage unit, or that image processing equipment may, in the alternative, be located distantly from the storage unit, receiving image sensor data via network or other transmission means. In yet other embodiments, the device image processing functionality may be widely distributed over equipment and networks employed by the invention for this purpose.

The image processing functionality of this device operates on image data received from the sensors to recognize objects in the storage unit. The processing latency for object recognition is on the order of seconds rather than minutes, sufficiently short as to be characterized as real-time. Embodiments may practice object recognition by image processing employing data structures that have been trained in the deep learning technologies of artificial intelligence, relying, for example, on convolutional network architecture, in some cases Space Displacement Neural Networks in particular, to ensure some degree of shift, scale and distortion invariance in the process of image recognition training. In some such image processing, a regularized linear model of a three dimensional object is created in software and the model is associated with the identity of the object. Thereby an initial dataset is created that correlates idealized representations of image data with object identity. Dataset augmentation is carried out by presenting an object recognition program/data structure in training with various transformations of object representations that do not change the class of object presented. Such transformations include random rotations, translations and in some cases random perturbation of colors and nonlinear distortions of the object representations. After many iterations of dataset augmentation, the image recognition software structure has been trained to identify objects represented in the image data, reliably and in real or near-real time.

While it will be recognized by those of skill in the art that many different programming and training approaches employing a range of supporting architectures can be used to implement object recognition in software, any image data processing means for providing reliable near-real time object identification from coded image data, without requiring user input or labeling of items, is adaptable to be incorporated for use in this invention. In accordance with the teachings of this invention, then, image processing receives image data as input and, through object recognition technology, provides item identification data as output. The invention's inventory database receives item identification data from the image processing equipment, enabling the creation of inventory data records as items are placed in and removed from the storage unit.

Embodiments of the invention further capture data indicating the gross weight of the storage unit and its contents, such as provided by weight sensor 122 in the refrigerator 102 illustrated in FIG. 1. For inventory purposes, embodiments employing a gross weight sensor obtain weight measurements of content by accurately measuring the delta between the empty or tare weight of the storage unit and the weight of the unit with content. To obtain the weight of content, embodiments of the invention may effectively offset the storage unit tare weight mechanically, for example by counterweight, or arithmetically by simply subtracting tare from gross weight.

Looking specifically at refrigerators, an average refrigerator weighs approximately 12 pounds per cubic foot of capacity. The tare weight range for full size consumer refrigerators in current use ranges from about 175 pounds up to nearly 400 pounds. The total content of a consumer refrigerator may weigh in the range of another 200 to 400 pounds. For effective inventory purposes, the weight of individual items in the refrigerator may need to be determined with an accuracy of 0.05 to 0.10 pounds. Commercially available scales operative with such a degree of resolution in an appropriate range include the Adam GF 660A Industrial Platform which has a range up to 660 pounds and a resolution of 0.05 pounds (available from Fotronic Corporation of Woburn, Mass.). Scales with such resolution are suitable for determining weights of individual items as they are added to or removed from refrigerator inventor.

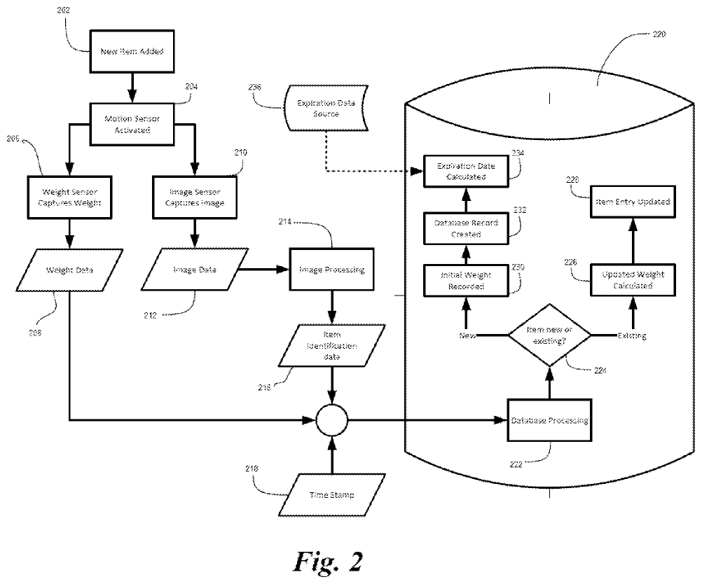

The determination of item identity and weight enables the invention to create and maintain inventory. FIG. 2 is a chart illustrating data acquisition and processing as an item is added to inventory in an embodiment of the invention. The user adds a new item 202 to the storage unit. This action is detected by sensor 204 which becomes activated on the addition of the item. In some embodiments, sensor 204 may be a motion detector. In other embodiments, not depicted here, the action of adding a new item is detected by changes in the overall weight of the storage unit and its contents. In yet other embodiments, actions to add or remove items from the storage unit can be detected by a sensor that is activated upon the opening of the door of the storage unit. In any case, on detection of such action a weight sensor 206 captures weight data 208 of the item and an image sensor 210 captures image data 212 of the storage unit's interior including the item. Image data 212 is processed by image processing functionality 214 with object recognition technology as discussed above to produce item identification data 216, identifying the item that has been placed in the storage unit. Embodiments of the present invention encompass all such means for determining whether the item is received in or removed from the storage unit and updating the inventory database accordingly

In this embodiment, weight data 208, item identification data 216 and a time stamp 218 generated by a system clock are communicated to inventory database 220 for database processing 222. Database processing 222 determines 224 whether the item is new to the inventory or whether an item of the same type is already existing in inventory. If the item is new, its initial weight is recorded 230. In the depicted embodiment, an authoritative external expiration data source 236 contains the expected usable lifetimes for various perishable items. A database record is created 232 for the item and, in the depicted embodiment, an expiry date is calculated 234 using data from the expiration data source 236, the expiration date then associated with the database record for the item. If database processing 222 determines 224 that the item is of the same sort as other items existing in inventory, then the total weight of those items is calculated 226 and the database record for that item type in inventory is updated 228.

The utility of minimizing food waste is afforded by tracking expiry dates of items in inventory, requiring a means for determining an item expiry date for the item. In the embodiment depicted in FIG. 2, the inventory database actually stores a calculated expiry date for an item. In other embodiments (not depicted), the inventory database can simply rely on the timestamp and identity of the item to perform a periodic cross-check of the item's current age with an expected lifetime for that type of item obtained from a database containing such information for various perishable items. Additionally, and in other embodiments as well, the inventory database can rely on actual expiry dates stamped onto the item's container, such as a “use-by” date stamped on containers of dairy products, recognized and read by object recognition functionality in such embodiments. Embodiments of the present invention encompass all such means for determining an item expiry date.

Embodiments of the present invention enable the user to minimize waste of perishable items in storage in various ways. Embodiments may enable a user to specify a minimum allowable period of time from the present to the expiration date of an item in inventory. The minimum period specified by the user will depend upon a number of user- and implementation-specific factors, such as inventory turn-over rate and the time required to resupply items. The user may specify a minimum period applicable to any item in the inventory. Alternatively, a user may specify different minimum times to expiry for different types of items in the inventory. Since some types of items deteriorate gradually as they near their expiry date while others deteriorate rapidly, specifying varied minimum times to expiry may be justified for some applications. As will be appreciated by those in the art, factors such as the above may determine a user-specified minimum time that can range from a day or days to weeks. In any case, embodiments can utilize a user-specified minimum time to expiration to trigger interaction between the invention and the user in the form of actionable alerts, helping the user minimize waste of perishable items, as further set forth below.

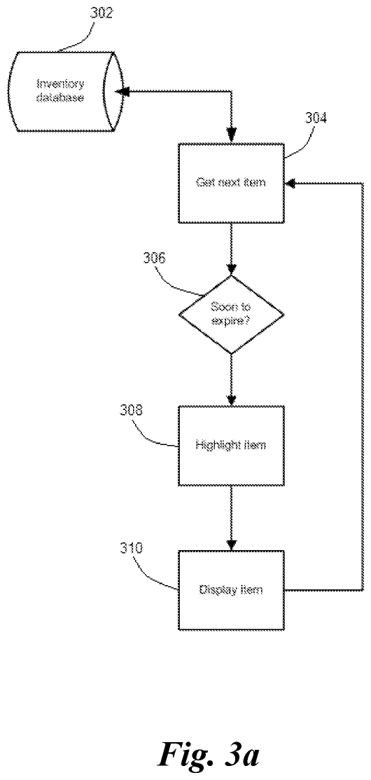

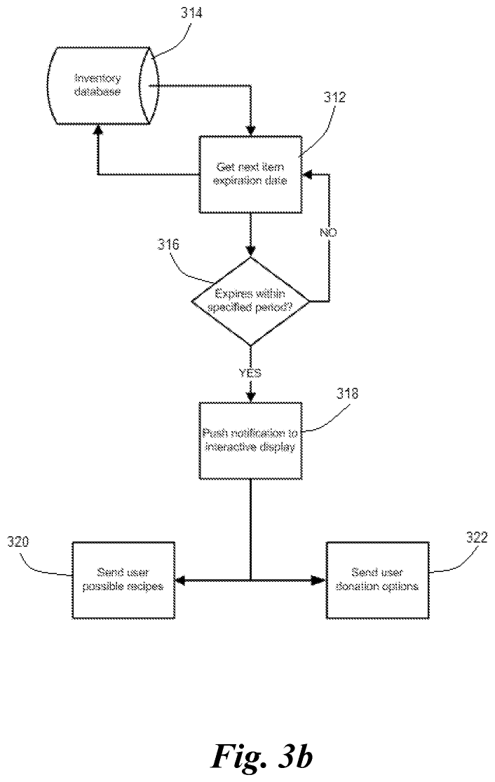

The database in embodiments of the invention permits a user to display a list of items in inventory. Because of the tracking expiry dates, a perishable item whose expiry date is within the specified minimum period may be highlighted in such a list, as illustrated for an exemplary embodiment in FIG. 3a in which an item is selected 304 from the inventory database 302 and the invention determines 306 whether its expiry date is within the specified period. If the item is to expire within the period, it is highlighted 308 and displayed 310 along with the other items that are not highlighted. This simple interface enables a user easily to identify which items in inventory are soon to expire and take appropriate action.

Embodiments of the invention can review expiration dates for items in inventory and provide information for the user to take specific appropriate action, as shown for an embodiment in FIG. 3b. Getting the expiration date for an item 312 from the inventory database 314, the invention determines whether the expiration date is within a user-specified minimum time to expiration from the current time 316. If the expiration date is farther out than the set time limit, the expiration date of another item 312 is examined. If the expiration date is within the set time limit for the item, notifications are pushed to an interactive display device 318. The display device may be a touchscreen integrated into the storage device, a laptop, a tablet, a smart phone, a desktop computer or any other device configured and connected to deliver notifications from the invention to the user. In the present exemplary embodiment, the invention sends the user actionable alerts in the form of information on possible recipes 320 to consume the expiring items and on donation options 322 should the user not care to consume the expiring items.

As will be readily understood by those of skill in the art, because embodiments inventory perishable items while tracking expiry dates, the alert functionality provided by the embodiment depicted in FIG. 3b may be provided by other means in various embodiments. For example, and not by way of limitation, in embodiments relying on operating systems such as UNIX, a background process daemon may be set for each perishable item, the daemon executing an alert notification to the interactive display device when the system clock indicates the expiry time for its perishable item is within the set time limit for the item. Yet other embodiments may rely on functionalities provided by a system calendaring application, such as Microsoft's Outlook, to implement timely notifications to the interactive display device of imminent expiry of perishable items. The present invention contemplates all such means for generating expiry notifications.

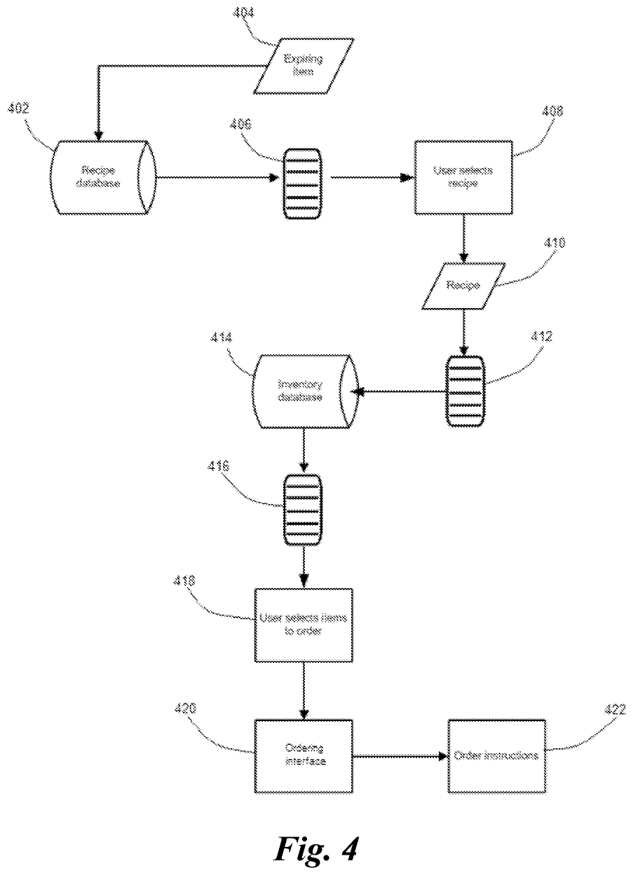

Expanding on actions regarding possible recipes for expiring perishable items, noted in 322 in FIG. 3b above, FIG. 4 illustrates an embodiment in which a database 402 of recipes with associated ingredients is queried for a list of recipes 406 containing the expiring item 404, list 406 displayed to the user as an actionable alert. A user may select 408 a recipe 410 from the list of recipes 406. Embodiments compare the list of ingredients 412 of recipe 410 with the items in the inventory database 414, and a list is created of ingredient shortfalls 416 in inventory of ingredients 412 for recipe 410. Embodiments may, either automatically or under user control 418, employ a provider order interface 420 to create order instructions 422 to procure the needed ingredients.

As will be appreciated by those in the art, other means for obtaining a list of recipes containing the expiring item may be employed within the spirit of the invention. For example, and not by way of limitation, manual or automated searches of the Internet can produce search results of recipes using a given ingredient. Common “scraping” technology can isolate ingredient and quantity requirements from the search results, providing the list of recipes and ingredients required by embodiments of the invention that provide possible recipes for expiring perishable items. All such means for obtaining at least one recipe listing for an item are contemplated in the present invention.

Embodiments may facilitate efficient use of perishable items within a larger context of inventory control. In some such embodiments, the invention may provide the user with an alert providing an indication that restocking of items is required, for example when the inventory database indicates that quantities of an item have fallen below a certain pre-set threshold, or, as shown at 416 in FIG. 4, when a there are insufficient quantities of an item required as an ingredient for a particular recipe. Advantageously, based upon anticipated expiration dates, embodiments may provide an alert that further indicates restocking of a perishable item that is soon to expire.

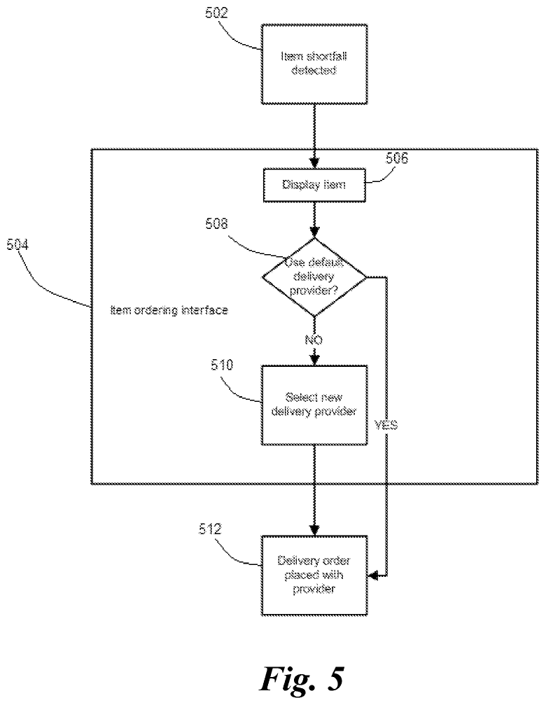

Turning now to FIG. 5, illustrated is the operation of an exemplary user interface providing the user with ordering options for the item in question. When an item shortfall is detected or anticipated 502, item ordering interface 504 is triggered displaying the item in question 506. The user is presented with the option of using a default delivery provider 508 for such item or selecting another delivery provider 510. It will be appreciated by those in the art that different delivery providers may be required for different items. Embodiments of the present invention may keep a database associating specific delivery providers with specific items. In any case, when a delivery provider has been selected, in the depicted embodiment the item ordering interface 504 enables placement of the item order automatically with the selected delivery provider 512.

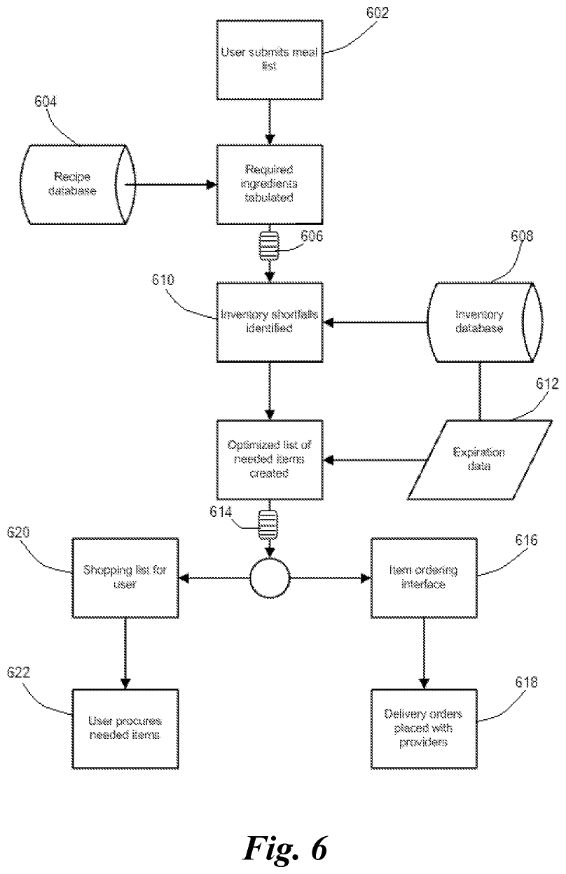

The invention can further assist the user in optimizing a user meal plan for utilization of perishable items. Turning to FIG. 6, the user enters a plan listing desired meals 602 through the interactive display. Accessing a structured recipe database 604, the invention determines and tabulates ingredients 606 required to prepare meals in the user's meal plan. Accessing the inventory database 608, shortfalls in inventory 610 are automatically identified. Accessing expiration data 612 associated with item records in the inventory database 608, a list is automatically created of needed items 614 optimized to maximize use of perishable items already in inventory. As described previously in reference to FIG. 5, the invention can present an item ordering interface 616 via the interactive display, for ordering items needed to prepare meals in the user's meal plan, utilizing a provider interface automatically to place delivery orders with providers 618. Alternatively, embodiments of the invention can create a shopping list 620 for the user to procure items 622 needed for the meal plan. As items are acquired for the meal plan and placed in the invention's storage, the recorded inventory of items is automatically updated as discussed previously in reference to FIG. 2.

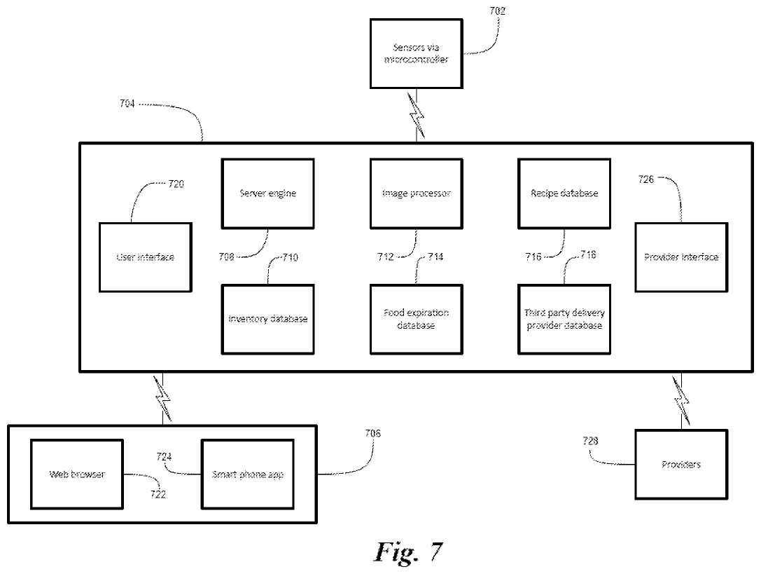

FIG. 7 is a block diagram illustrating an embodiment of the present invention. Sensor data is communicated by microcontroller 702 networked to associated data processing equipment. The s data processing equipment is shown generally as a server/client configuration comprising server component 704 in networked communication with client component 706. Server 704 comprises a server engine 708, an inventory database 710, and the functionalities of an image processor 712 for object identification, a food expiration database 714, a recipe database 716 and a third party delivery provider database 718. Those of skill in the art will recognize that various server functionalities such as image processor 712, food expiration database 714, recipe database 716 and third party delivery provider database 718 may rely on external sources of data for their operation yet still be in keeping with the teachings of the present invention.

In the depicted embodiment, a user interface 720 is provided to enable server 704 to interact with client 706 via the Internet over the World Wide Web to provide the user with supervisory and actionable inventory management capabilities via common network client functionalities such as web browser 722 and smart phone app 724. It will be appreciated by those of skill in the art, however, that embodiments of the invention may alternatively use various other communication channels and protocols, such as local area networks (LANs), wide area networks or peer-to-peer systems, alone or in combination, for communication between the various device components in keeping with the spirit of the present invention. As will be further appreciated by those of skill in the art, the networked browser 722 and smart phone 724 are simply instantiations of an interactive display device that, in some embodiments, may be provided by a touch screen or similar hardware, directly connected to the storage device.

The depicted embodiment also comprises a provider interface 726, employing a communication channel to interact with external providers 728 of items. Provider interface 726 enables ordering of new inventory items from providers 728, either as directed by the user via user interface 720 or automatically under control of server engine 708 such as when shortfalls are indicated in inventory database 710.

Persons of skill in the art will recognize that user interface 720 need not be implemented in whole within server 704 but rather may at least be partially implemented in client 706. Persons of skill in the art will further recognize that server 704 may communicate with a provider client system (not illustrated) at a provider 728 whereby part or all of provider interface 726 is implemented in such provider client system.

Although the present invention has been described in terms of various embodiments, it is not intended that this device be limited to these embodiments. For example, embodiments of the invention can be utilized for inventory management in other environments where no-touch inventory recording would be preferred. The data created by the invention may also be used in different ways. For example, new items can be announced via voice command spoken to the user.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

I claim:

1. A storage unit for perishable inventory, comprising:
a container;
at least one image sensor disposed within the container, the at least one image sensor configured to transmit an image dataset of an item received in or removed from the container;
an image processor configured to receive the image dataset from the at least one image sensor, the image processor further comprising means for processing the image dataset to derive an item identification datum identifying the item;
a means for determining an expected item expiry date for the item;
an inventory database containing records of items in the container, an item record comprising the item identification datum and the expected item expiry date;
a database processing means for determining whether the item is received in or removed from the container and updating the inventory database accordingly; and
a supervisory data processor, providing an alert to a user when the expected item expiry date of the item record corresponding to the item in the inventory database is less than a designated period from present.

2. The storage unit according to claim 1, wherein the means for determining the expected item expiry date comprises a database query engine operating on a database of lifespans for perishable items.

3. The storage unit according to claim 1, wherein the means for determining the expected item expiry date comprises a further configuration of the image processor to derive the expected item expiry date from expiry date data printed on an item container.

4. The storage unit according to claim 1, further comprising a gross weight sensor, the gross weight sensor configured to calculate and transmit an item weight datum for an item, and the item record further comprises the item weight datum.

5. The storage unit according to claim 1, in which the supervisory data processor further comprises a means for obtaining an at least one recipe listing for an item and in which the alert further comprises presenting the at least one recipe listing to the user.

6. The storage unit according to claim 5, in which the means for obtaining the at least one recipe listing for an item comprises a database query engine operating on a structured database of recipes and ingredients.

7. A storage unit for perishable inventory, comprising:
a container for receiving items;
at least one image sensor disposed within the container, the at least one image sensor configured to transmit an image dataset of an item entering the container;
an image processor configured to receive the image dataset from the at least one image sensor, the image processor further comprising means for processing the image dataset to derive an item identification datum identifying the item;
an inventory database manager receiving the item identification datum from the image processor and configured to update an inventory database, the inventory database containing records of items in the container, an item record comprising the item identification datum and a record time stamp, and
a supervisory data processor, periodically obtaining the item identification datum and the record time stamp for the item record and determining a time in storage for the item from the record time stamp, the supervisory data processor further configured to query a freshness database of expected shelf life of items to obtain an expected shelf life of the item corresponding to the item identification datum, the supervisory data processor further providing an alert to a user if the time in the container for the item is within a designated period from the expected shelf life of the item.

8. The storage unit according to claim 7, in which the at least one image sensor is further configured to transmit withdrawal data of an item as it is removed from the container and the inventory database manager is configured to update the item record corresponding to the item in the inventory database accordingly.

9. The storage unit according to claim 8, in which the supervisory data processor further comprises a means for obtaining an at least one recipe listing for an item and in which the alert further comprises presenting the at least one recipe listing to the user.

10. An interactive refrigerator, comprising:
at least one image sensor disposed therein, the at least one image sensor configured to transmit an image dataset of an item inbound or outbound;
a means for processing the image dataset from the at least one image sensor to provide an item identification;
a scale providing an item weight;
a means for obtaining an expected item expiry date;
an inventory database comprising records of item identifications, item weights and item expiry dates;
a means for determining if the item is inbound or outbound;
a means for adding an item record comprising the item identification, the item weight and the expected item expiry date to the inventory database if the item is inbound;
a means for subtracting the item record from the inventory database if the item is outbound; and
an interactive display device configured to provide a user with an actionable alert for a perishing item, the perishing item comprising one for which the expected item expiry date in the item record is within a user-specified minimum from current time.

11. The interactive refrigerator according to claim 10, wherein the interactive display device is further configured to display records in the inventory database and wherein the actionable alert comprises highlighting the item record of the perishing item.

12. The interactive refrigerator according to claim 10, further comprising a recipe database, each record of which comprises a recipe and an associated ingredient list, and in which the actionable alert comprises a display of at least one recipe from the recipe database in which the perishing item is an ingredient.

13. The interactive refrigerator according to claim 12, in which the interactive display device is further configured to receive input from the user of a selected recipe from the display of at least one recipe.

14. The interactive refrigerator according to claim 13, further comprising an inventory query engine operating on the associated ingredient list of the selected recipe to produce a shortfall list of ingredients in the associated ingredient list but not in the inventory database and the interactive display device is further configured to show the shortfall list of ingredients.

15. The interactive refrigerator according to claim 10, further comprising a provider interface, and wherein
the interactive display device is further configured to accept user input identifying items to be procured, and
the provider interface is configured to transmit order instructions to providers of items that the user has identified to be procured.
